(19) United States
(12) Patent Application Publication
(10) Pub. No.: US 2017/0165150 A1
(43) Pub. Date: Jun. 15, 2017

(54) DEVICE FOR ASSISTING SEXUAL STIMULATION

(71) Applicant: William Whitney, Lyons, OR (US)

(72) Inventor: William Whitney, Lyons, OR (US)

(21) Appl. No.: 14/967,126

(22) Filed: Dec. 11, 2015

(51) Int. Cl. A61H 19/00

(52) U.S. Cl. CPC A61H 19/44; A61H 19/40; A61H 2201/0119; A61H 2201/0107; A61H 2201/1628

(57) ABSTRACT

Sexual aids, including a device for giving and receiving sexual pleasure comprising at least two handles that are positioned on either side of a bar, are disclosed herein. In some examples, the device includes adjustable handles. In some further examples, the device includes an expandable bar. In still further examples, the device is equipped with specially designed toys, but is also customizable to work with the user's preferred toy.

### BACKGROUND

The present disclosure relates generally to devices for sexual stimulation. In particular, sexual stimulation devices with handles are described.

Known sexual stimulation devices are not entirely satisfactory for the range of applications in which they are employed. For example, existing devices typically are not equipped with handles to assist those who may have physical limitations. In addition, conventional sexual stimulation devices are only configured for one or two users at the most; they do not contemplate simultaneous use with multiple partners. Further, conventional sexual stimulation devices are not customizable according to a person's preferred method of use. Finally, known sexual stimulation devices do not expand and retract to provide a better fit to the user's unique body type. Thus, there exists a need for sexual stimulation devices that improve upon and advance the design of known devices.

### SUMMARY

The present disclosure is directed to a device for giving and receiving sexual pleasure that has at least two handles that are positioned on either side of a bar. In some examples, the device includes adjustable handles. In some further examples, the device includes an expandable bar. In still further examples, the device is equipped with specially designed toys, but is also customizable to work with the user's preferred toy.

### BRIEF DESCRIPTION OF THE DRAWINGS

FIG. 1A is a perspective view of a first example of a sexual aid according to one embodiment of a present invention.

FIG. 1B is a perspective view of the underside of a first example of a sexual aid according to one embodiment of the present invention.

FIG. 2 is a partially exploded view of an embodiment of base 110 and one embodiment of left handle 150 and right handle 130 of the sexual aid according to FIG. 1.

FIG. 3 is a perspective view of an example of a sexual aid according to one embodiment of the present invention.

FIG. 4 is an exploded view of a left handle and a right handle according to one embodiment of the sexual aid shown in FIG. 1.

FIG. 5 is an exploded view of an extended handle according to an alternative embodiment of the invention in FIG. 1.

FIG. 6 is a perspective view of an alternative embodiment of the present invention.

### DETAILED DESCRIPTION

The disclosed device for assisting sexual stimulation will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various devices for assisting sexual stimulation are provided. Related features in the examples may be identical, similar, or dissimilar in different examples. For the sake of brevity, related features will not be redundantly explained in each example. Instead, the use of related feature names will cue the reader that the feature related feature name may be similar to the related feature in an example explained previously. Features specific to a given example will be described in that particular example. The reader should understand that a given feature need not be the same or similar to the specific portrayal of a related feature in any given figure or example.

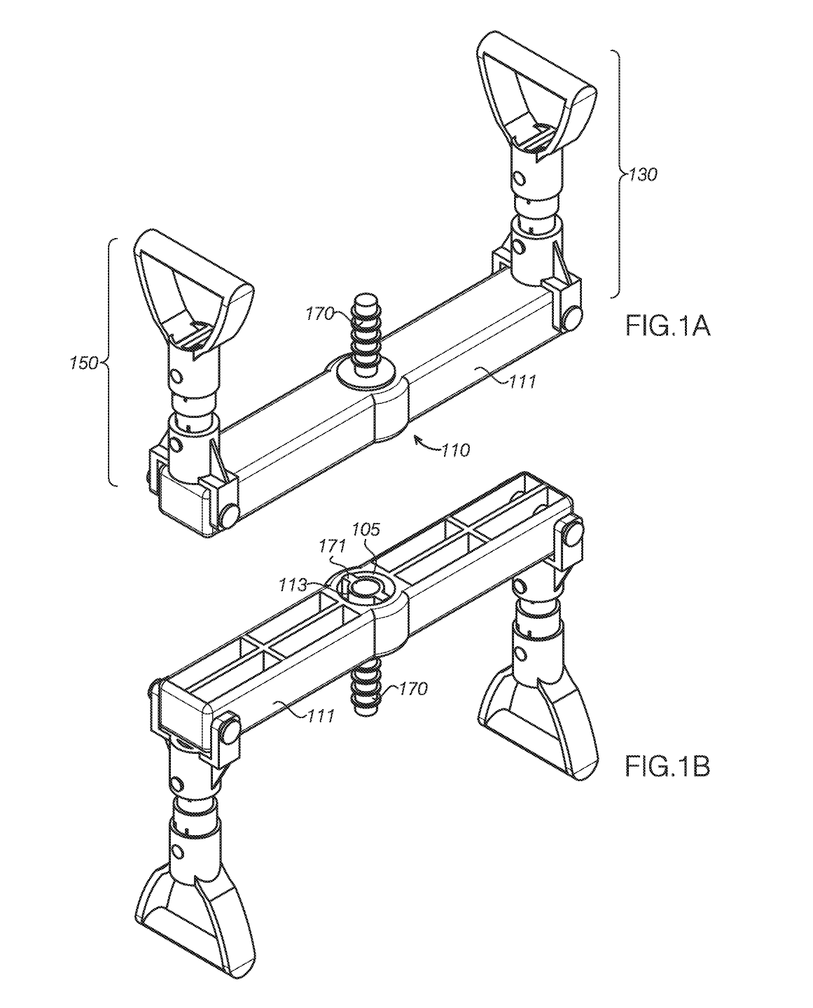

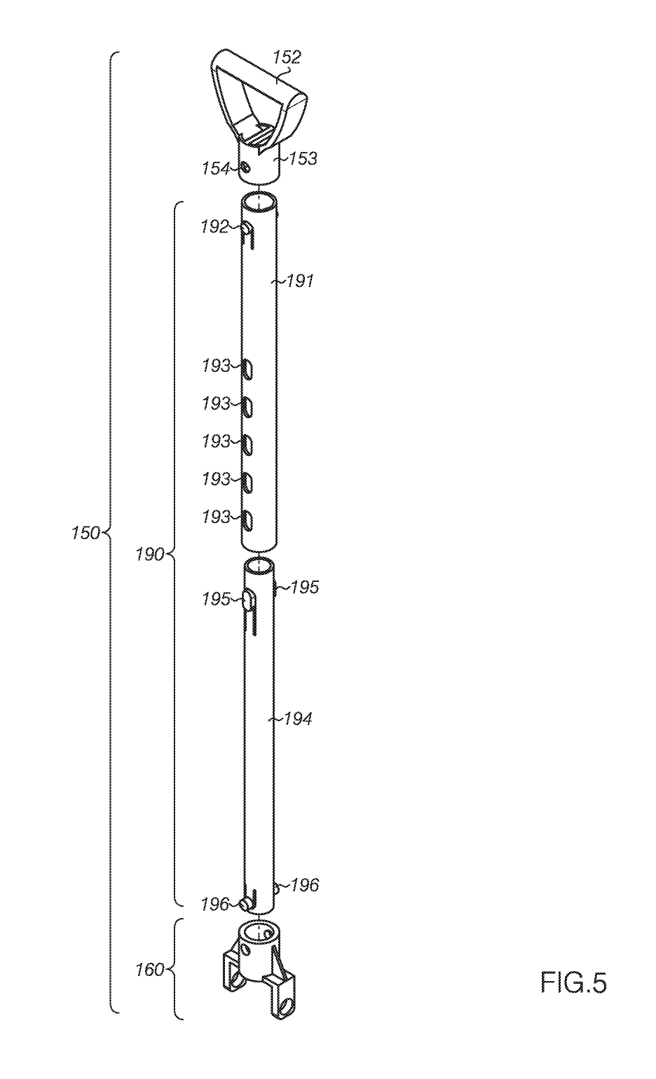

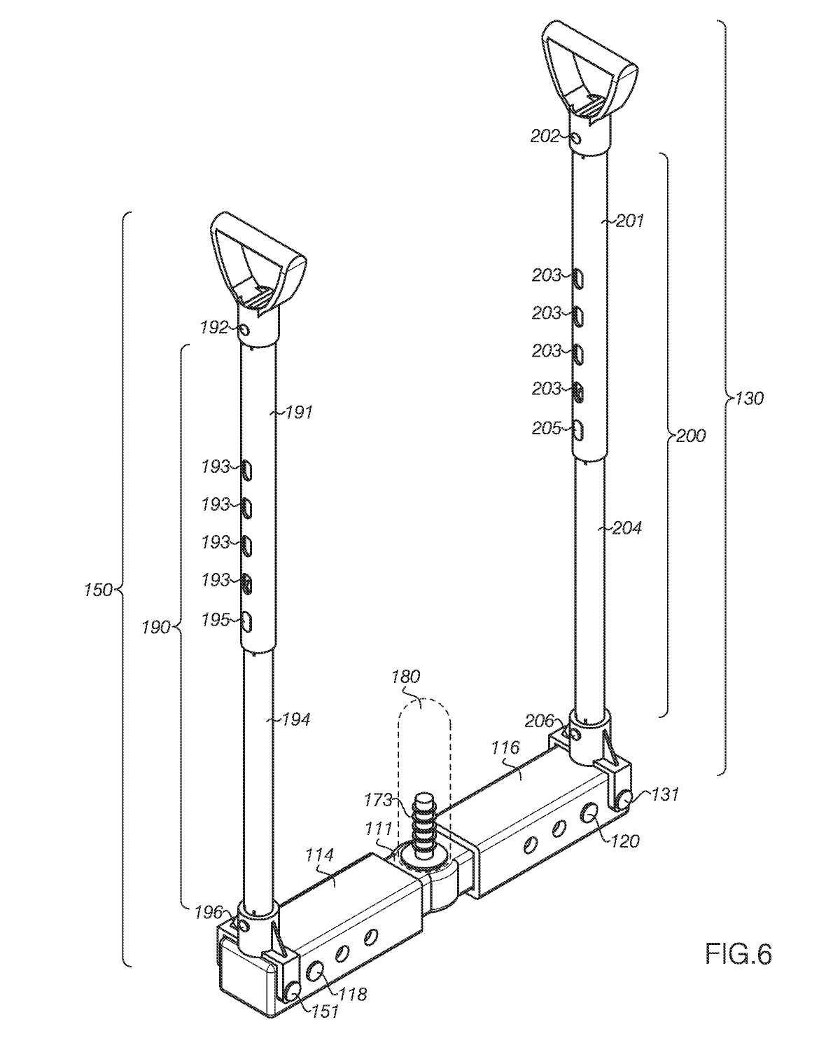

With reference to FIGS. 1-4, a first example of a device for assisting sexual stimulation, sexual aid 100, will be described. With reference to FIGS. 5-6, a second example of sexual aid 100 will also be described. Sexual aid 100 functions to enhance the sexual experience of a user or users who may want, or require, assistance in giving and receiving sexual pleasure. The reader will appreciate from the figures and description below that sexual aid 100 addresses shortcomings of conventional adult sexual stimulation devices.

For example, sexual aid 100 is equipped with handles to assist those who may have physical limitations. In addition, sexual aid 100 is configured to accommodate a single user or, in the alternative, multiple users. Further, sexual aid 100 is customizable according to the user's preferred method of use and can easily and quickly be assembled and disassembled for discreet storage and transport. Finally, sexual aid 100 is configured to expand and retract to provide a better fit to the user's body.

As can be seen in FIG. 1A, sexual aid 100 includes a base 110, left handle 150, a right handle 130, and a toy stem 170. In alternative embodiments (not shown), sexual aid 100 may include additional or alternative features, such as a customizable toy or set of toys, additional handle extenders, and additional base extenders. Also shown FIG. 1, base 110 may comprise a bar 111, to which left handle 150 and right handle 130 are attached. In alternative embodiments (shown and discussed in further detail below), base 110 may comprise bar 111, left receptacle 114, and right receptacle 116. Bar 111 may also comprise a toy stem 170 for removably receiving an adult toy.

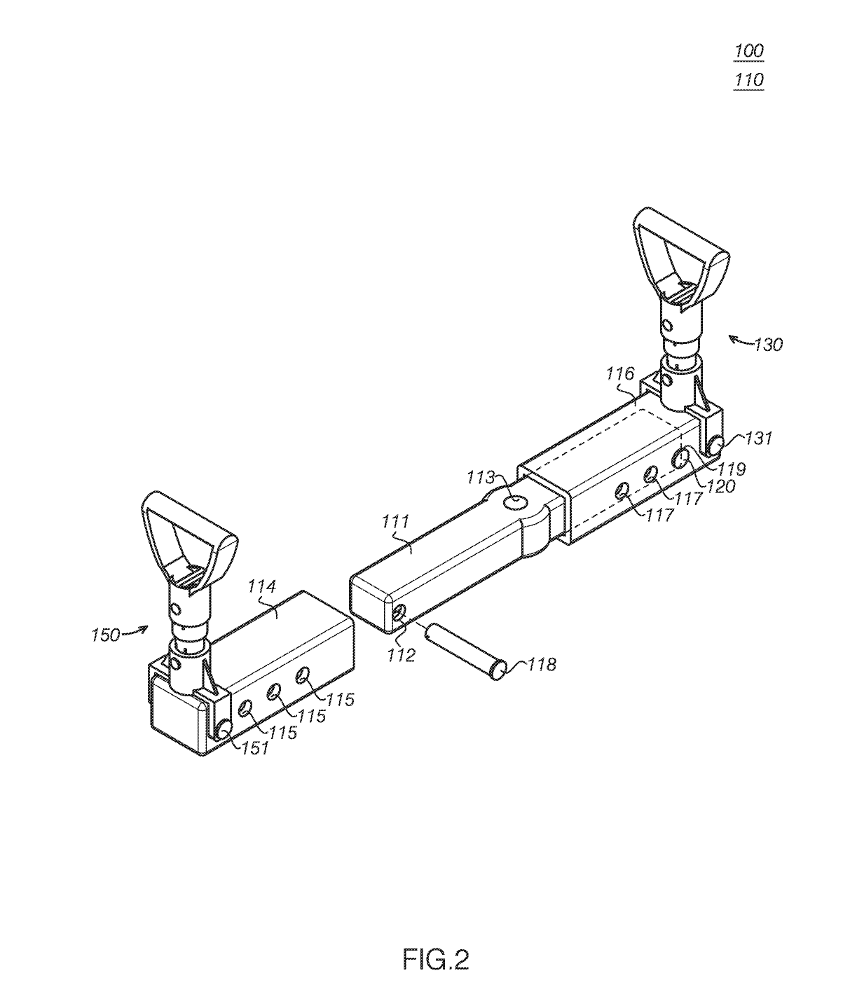

As shown in FIG. 1B, base 110 also includes recess 105. In a preferred embodiment, recess 105 is located in the center of bar 111 and comprises an indentation that traverses more than halfway through the vertical height of bar 111 as shown. In this manner, recess 105 is a hollow portion located on the underside of base 111, but does not traverse the entire height of bar 111; only toy stem aperture 113 traverses all the way through bar 111 (as can be seen in FIG. 2). In a preferred embodiment, recess 105 is substantially circular, however it is an object of the present invention that recess 105 may be of any shape and dimension sufficient to accommodate a toy stem securing means 171. In the present embodiment, toy stem securing means 171 is a wing nut, however, it should be understood that toy stem securing means 171 may be any type of securer sufficient to retain toy stem 170 in place. Further, as can be seen in the figures, toy stem aperture 113 is located substantially in the center of recess 105 and is configured to removably receive toy stem 170. Thus, the underside of base 111 is substantially planar in order to increase comfort and reduce the risk of injury when sexual aid 100 is in use.

Referring now to FIG. 2, a partially exploded view of an embodiment of base 110 and one embodiment of left handle 150 and right handle 130 are shown. In the present embodiment, sexual aid 100 comprises base 110, left handle 150 and right handle 130. As shown in this embodiment, base 110 comprises bar 111, left receptacle 114, and right receptacle 116. It should be understood that it is an object of the present invention that base 110 may comprise only bar 111, bar 111 and left receptacle 114, bar 111 and right receptacle 116, or bar 111, left receptacle 114, and right receptacle 116. Further, as explained in detail below, the dimensions of left handle 150 and right handle 130 are identical, thus, left handle 150 and right handle 130 and their component parts are interchangeable. In this manner, left handle 150 is capable of attaching to right receptacle 116 and right handle 130 is capable of attaching to left receptacle 114. Similarly, left handle 150 may attach to the right side of bar 111 and right handle 130 may attach to the left side of bar 111.

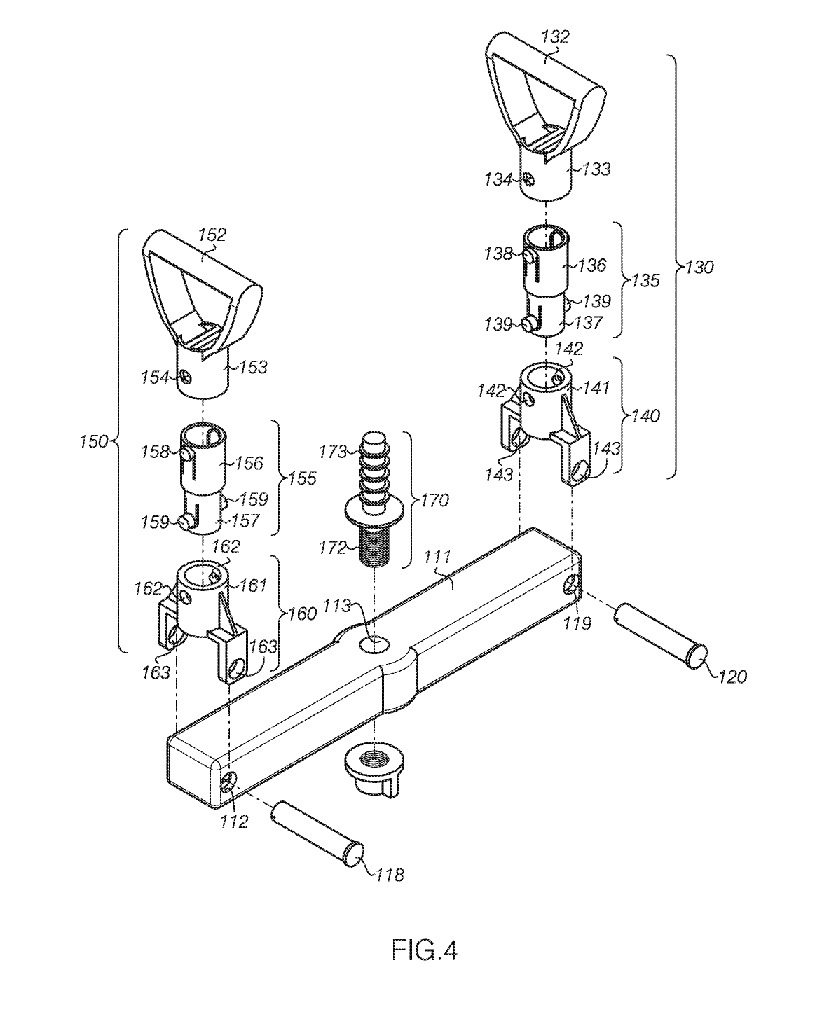

As can be seen in FIG. 2, in the present embodiment, bar 111 further comprises a left bar peg 118, a left bar peg aperture 112 and a right bar peg aperture 119 (both shown in FIG. 4). In the present embodiment, bar 111 further comprises a right bar peg 120 and toy stem aperture 113. According to the present embodiment, left receptacle 114 further comprises a plurality of left receptacle apertures 115, a left receptacle peg 151. Similarly, right receptacle 116 further comprises a plurality of right receptacle apertures 117 and a right receptacle peg 131. FIG. 2 shows bar 111. Left receptacle 114, and right receptacle 116 as being substantially rectangular, however it should be understood that bar 111, left receptacle 114, and right receptacle 116 may be cylindrical, triangular, cuboid, or any other 3 dimensional shape sufficient to accomplish its intended purpose, which is to function as the center piece for base 110. It is an object of the present invention that the shape of bar 111, left receptacle 114, and right receptacle 116 are complementary. That is to say, the dimensions and configurations of each are such that they work together in concert to effectuate widening of base 110. It should further be understood that bar 111 may be of varying lengths and widths in order to permit base 110 to accommodate differing body types and sizes.

As mentioned above, bar 111 comprises a left bar peg aperture 112 a right bar peg aperture 120, a left bar peg 118, and a right bar peg 119. Right bar peg aperture 120 is configured to removably receive right bar peg 119 and left bar peg aperture 112 is configured to removably receive left bar peg 118 as shown. It should be understood that the dimensions left receptacle aperture(s) 115 are identical to left bar peg aperture 112 and the dimensions of right receptacle aperture(s) 117 are identical to right bar peg aperture 120. Similarly, the dimensions of left bar peg 118 and right bar peg 119 are identical and complimentary to left receptacle aperture(s) 116 and right receptacle apertures 117. Thus, it should be understood that right receptacle aperture 118 and right bar peg aperture 120 are capable of removably receiving left bar peg 118 and vice versa.

As indicated by the dotted lines in the present figure, bar 111 is shown inserted into right receptacle 116. This, bar 111 may be removably received by left receptacle 114 and right receptacle 115 at either distal end as shown. Thus, when the user wishes to increase the overall length of base 110, he or she may do so by attaching left receptacle 114 and/or right receptacle 116 to bar 111. In order to accomplish this, the user may slide left receptacle 114 outward and/or right receptacle 116 outward. In this manner, left bar aperture 112 will be positioned behind one of the plurality of left receptacle aperture 115. Similarly, right bar aperture 120 will be positioned behind one of the plurality of right receptacle aperture 117. In the present figure, right receptacle 116 is shown secured to bar 111 whereby right bar aperture 120 is placed behind right receptacle aperture 117 and secured with right bar peg 120 as shown.

The user will then secure left receptacle 114 to bar 111 by inserting left bar peg 118 through left receptacle aperture 115 and left bar aperture 112. Similarly, the user will then secure right receptacle 116 to bar 111 by inserting right bar peg 119 into the selected right receptacle aperture 117 and right bar aperture 120 as shown. In this manner, the overall length of base 110 may be shortened or widened according to the user preferences. As mentioned above, the dimensions of the bar apertures 112/120 and the receptacle apertures 115/117 are complementary and congruent with each other and the bar pegs 118/119 and the receptacle pegs 151/131. Thus, the user may select from a variety of positions of bar 111 and the receptacles 114/116 to determine a length of base 110 that works best for his or her unique needs, abilities, and body type. In this manner, sexual aid 100 is customizable according to the user's and/or user's partner(s) body type(s). In alternative embodiments (not shown) sexual aid 100 may include several of bar 111 of varying lengths for increased customization. In this manner, when the user wishes to widen bar 110 even further, he or she may simply attach bar 111 to a second bar 111 via a second left bar peg and a second right bar peg.

Similarly, when the user wants to decrease the overall length of base 110, she may do so by removing left bar peg 118 and sliding left receptacle 114 to a different aperture 115/117 or off of bar 111 completely. She may also remove right bar peg 120 and slide right receptacle 116 off of bar 111. The user may then attach left handle 150 and right handle 130 to bar 111 via left bar peg 118 and right bar peg 119 as shown. By way of example, FIG. 2 depicts right handle 130 attached to right receptacle 11g in the distal most right receptacle aperture 117, and right receptacle 116 as being slid the furthest inside of bar 111 and fastened via the second most distal right receptacle aperture 117 through right bar aperture 120 via right bar peg 119. It is an object of the present invention that right handle 130 may attach to right receptacle 116 via any of the right receptacle apertures 117 and that the dimensions or right receptacle aperture 117 and right bar aperture 119 are complimentary and designed to accommodate right bar peg 120 and right receptacle peg 131 alike.

As mentioned above, base 110 also comprises toy stem aperture 113. In a preferred embodiment, toy stem aperture 113 comprises a threaded hole capable of removably receiving toy stem 170 (shown and described in FIG. 4). In alternative embodiments (not shown) bar 111 may comprise more than one toy stem aperture 113. In this manner, the user may employ more than one toy when sexual device 100 is in use. It should be understood that toy stem aperture 113 is designed to work in concert with toy stem 170 (discussed in further detail below). In still other embodiments (not shown), an adult toy may be affixed directly to bar 111 without the need of stem 170 or toy stem aperture 113. By way of example, the figures show toy stem 170 and toy stem aperture 113 to be of a substantially nut and bolt configuration. It should be understood that in alternative embodiments, and adult toy may be affixed to bar 111 in any means reasonable to accomplish this task, including but not limited to, friction fit, clips, snaps, cotters, and the like.

As mentioned above, left receptacle and right receptacle further comprise left receptacle apertures and right receptacle apertures respectively. It should be understood that the dimensions of left receptacle aperture(s) 115, right receptacle aperture(s) 117, left bar peg aperture 112, and right bar peg aperture 120 are identical. It follows then, that the dimensions right bar peg 119 and left bar peg 118 are also identical. It should further be understood that that the dimensions of left receptacle aperture(s) 115, right receptacle aperture(s) 117, left bar peg aperture 112, and right bar peg aperture 120 are slightly larger than the dimensions of right bar peg 119 and left bar peg 118 to allow for removable insertion. As shown in the figures, right bar peg 119 and left bar peg 118 appear as substantially cylindrical. Similarly, left receptacle aperture(s) 115, right receptacle aperture(s) 117, left bar peg aperture 112, and right bar peg aperture 120 appear as substantially round. It is an object of the present invention that the shape of the pegs and apertures may be of any shape to accomplish the purpose of securing left receptacle 114 and right receptacle 116 to bar 111 in the manner described above.

By way of example, the figures show the number of left receptacle aperture 115 and right receptacle aperture 117 to be four. It should be understood that the number of receptacle apertures may be more or less than four depending on the length of left receptacle and right receptacle. Similarly, the figures show bar 111 as having a single left bar aperture and a single right bar aperture. In alternative embodiments (not shown), bar 111 may comprise any number of left bar aperture 115 and right bar aperture 117 as needed and according to the length of the bar.

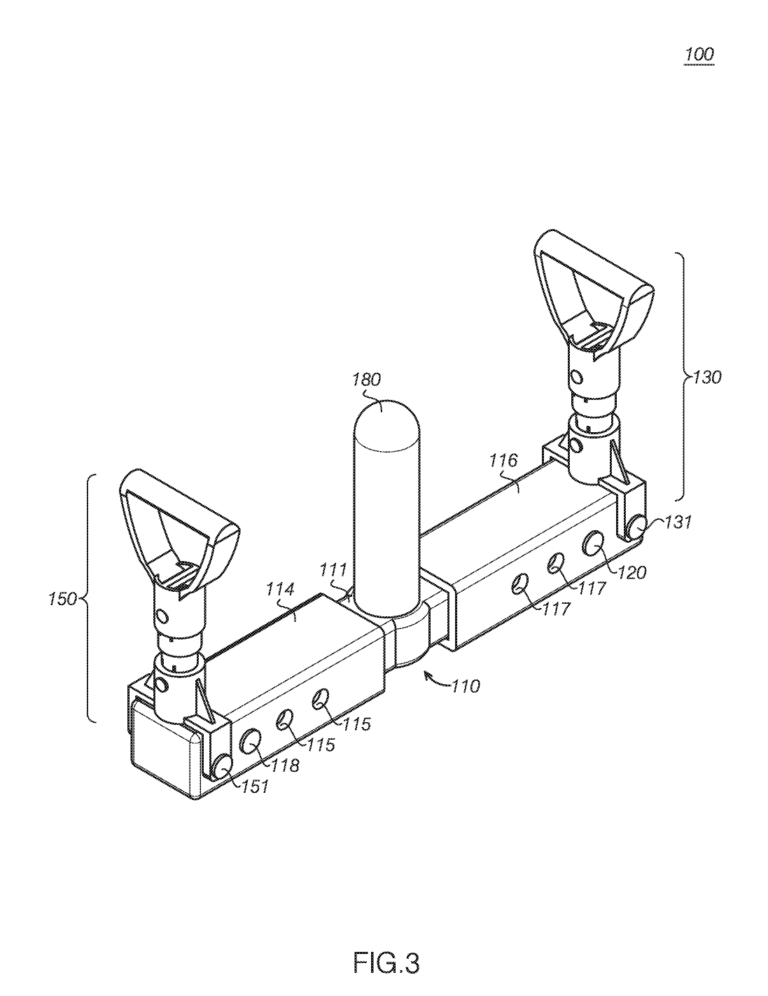

Referring now to FIG. 3, one embodiment of an assembled sexual device 100 is shown. In the present embodiment, base 110 comprises the shortest length possible that can be achieved with left receptacle 114 and right receptacle 116. By way of example, FIG. 3 depicts right bar peg 120 inserted into the right receptacle aperture 117 that is closest to right handle 130. Similarly, and also by way of example, FIG. 3 depicts left bar 118 inserted to the left receptacle aperture 115 that is closest to left handle 150 as shown. In alternative embodiments, the user may slide left receptacle 114 outward such that left bar peg aperture 112 aligns with left receptacle 115 aperture and is secured with left bar peg 118, thus extending the overall length of base 110.

Also shown in FIG. 3 is a first example of an adult toy 180. In the present figure, adult toy 180 is substantially phallic-shaped, however, it should be understood that the adult toy can be of any shape or size (phallic or yonic) that the user prefers.

Referring now to FIG. 4, an exploded view of left handle 150 and right handle 130 is shown. Left handle 150 comprises a left gripping means having a left grip 152, a left grip receptacle 153 and a left grip receptacle aperture 154. Left handle 150 further comprises a left handle coupling means 155 comprising a left grip connector 156 having a pair of left receptacle connector tabs 158 and a left clevis connector 157 having a pair of left clevis connector tabs 159. Finally, left handle 150 further comprises a left clevis 160 having a left clevis receptacle 161 comprising a pair of left clevis connector tab receptacle 162 and a pair of left clevis aperture 163.

Similarly, right handle 130 comprises a right gripping means having a right grip 132, a right grip receptacle 133 and a right grip receptacle aperture 134. Right handle 130 comprises a right gripping means having a right grip 132, a right grip receptacle 133 and a right grip receptacle aperture 134. Right handle 130 further comprises a right handle coupling means 135 comprising a right grip connector 136 having a pair of right receptacle connector tabs 158 and a right clevis connector 137 having a pair of right clevis connector tabs 139. Finally, right handle 150 further comprises a right clevis 140 having a right clevis receptacle 141 comprising a pair of right clevis connector tab receptacle 142 and a pair of right clevis aperture 143.

It should be understood that left handle 150 and right handle 130 are interchangeable. For the sake of simplicity, the handles 150/130 are defined in terms of “left” and “right”, however, it is an object of the present invention that the user may use either handle on either side of base 110 pr either receptacle 114/116.

In order to assemble sexual aid 100 for use, the user will attach left handle 150 and right handle 130 to base 110. As shown in FIG. 4, left handle 150 and right handle 130 are attached to bar 111, however it should be understood that left handle 150 and right handle 130 may be attached to left receptacle 114 and right receptacle 116 (as shown in FIG. 2). It should further be understood that, in alternative embodiments (not shown), left handle 150 may be attached to bar 111 while right handle 130 may be attached to right receptacle 116 or right handle 130 may be attached to bar 111 and left handle 150 may be attached to left receptacle 114. In this manner, base 110 is customizable to the user's preference, number of partners, and body type.

When the user wishes to employ sexual aid 100, he or she may begin by attaching the handles 130/150 to base 110. It should be understood that the order in which the user assembles the handles 130/150 is not important. By way of example, the steps of assembly are discussed below, however it is an object of the present invention that the user may assemble the pieces in any manner he or she chooses. By way of example, then, to assemble left handle 150, the user will position left clevis 160 over bar 111 such that left clevis apertures 163 are positioned over the corresponding base aperture. As shown in FIG. 4, the corresponding base aperture is left bar aperture 112. The user will then secure left clevis 160 to base 110 by inserting left bar peg 118 through left bar peg aperture 112 and left clevis apertures 163. In alternative embodiments (shown in FIG. 2), left clevis 160 is positioned over left receptacle 115 such that left clevis apertures 163 are positioned over the preferred left receptacle aperture 115 and secured with left receptacle peg 151. In this manner, the user may determine the preferred width of base 110. It should be understood that it is an object of the present invention that left clevis 160 and right clevis 140 may also attach to left receptacle 114 and right receptacle 116 via the left receptacle apertures 115 and the right receptacle apertures 117 in the same manner as described above.

The user will then attach left handle coupling means 155 to clevis 160 via left clevis connector tab 159. Left clevis connector tab 159 is depressible and comprises a diameter that is less than the diameter of left clevis connecter tab aperture 162. The user will depress left clevis connector tab 159 and insert left clevis connector 157 into left clevis receptacle 162. Thus, when left clevis connector tab 159 comes into contact with left clevis connector 157, left clevis connector tab 159 remains depressed until it comes into contact with left clevis tab receptacle 162, at which point left clevis connector tab 159 springs out and through left clevis connector tab receptacle 162 and secures left clevis connector 157 to left clevis 160.

In order to attach left grip 152 to left handle coupling means 155, the user will place left grip receptacle 153 over left grip connector 156. Left grip connector tab 158 is depressible and comprises a diameter that is less than the diameter of left grip receptacle aperture 154. Left grip connector 156 into left grip receptacle 153. Thus, when left grip receptacle tab 158 comes into contact with left grip receptacle 153, left grip connector tab 158 remains depressed until it comes in contact with left grip receptacle aperture 154, at which point left grip connector tab 158 springs out and through left grip receptacle aperture 154 and secures left grip 153 to left handle coupling means 155. FIG. 1 depicts a completely assembled left handle 150 in the manner described above.

Similarly, when the user wishes to attach right handle 130, she will repeat the same steps. By way of example, then, to assemble right handle 130, the user will position right clevis 140 over bar 111 such that right clevis apertures 143 are positioned over the corresponding base aperture. In the present figure, right clevis apertures 143 are positioned over right bar aperture 119. The user will then secure right clevis 140 to base 110 by inserting right bar peg 120 through right bar peg aperture 119 and right clevis apertures 143. In alternative embodiments (shown in FIG. 2), right clevis 140 is positioned over right receptacle 114 such that right clevis apertures 143 are positioned over the preferred right receptacle aperture 117 and secured with right receptacle peg 131. In this manner, the user may determine the preferred width of base 110. It should be understood that it is an object of the present invention that left clevis 160 and right clevis 140 may also attach to left receptacle 114 and right receptacle 116 via the left receptacle apertures 115 and the right receptacle apertures 117 in the same manner as described above.

The user will then attach right handle coupling means 135 to right clevis 140 via right clevis connector tab 139. Right clevis connector tab 139 is depressible and comprises a diameter that is less than the diameter of right clevis connecter tab aperture 142. The user will depress right clevis connector tab 139 and insert right clevis connector 137 into clevis receptacle 142. Thus, when right clevis connector tab 139 comes into contact with right clevis connector 137, right clevis connector tab 139 remains depressed until it comes into contact with right clevis tab receptacle 142, at which point right clevis connector tab 139 springs out and through right clevis connector tab receptacle 142 and secures right grip connector 137 to right clevis 140.

In order to attach right grip 132 to right handle coupling means 135, the user will place right grip receptacle 133 over right grip connector 136. Right grip connector tab 136 is depressible and comprises a diameter that is less than the diameter of right grip receptacle aperture 134. Right grip connector 136 into right grip receptacle 133. Thus, when right grip receptacle tab 138 comes into contact with right grip receptacle 133, right grip connector tab 138 remains depressed until it comes in contact with right grip receptacle aperture 134, at which point right grip connector tab 138 springs out and through right receptacle aperture 134 and secures right grip 133 to right handle coupling means 135. FIG. 1 depicts a completely assembled left handle 150 in the manner described above.

As shown in FIG. 4, grip is substantially semicircular with a flat portion for grasping with the user's hands or feet. As shown in FIG. 4, handle is connected to bar 111 via left bar peg aperture 112, however it is an object of the present invention that left handle 150 and right handle may also connect to left receptacle 114 and right receptacle 116, as shown in FIG. 2

Also shown in FIG. 4 is toy stem 170. Toy stem 170 further comprises a toy stem securing means 171, a base male attaching means 172, and a toy male attaching means 172. It is an object of the present invention that toy 180 is designed to fit specifically with toy stem 170, however, in alternative embodiments, toy 180 may be a pre-manufactured device that may be modified to work with toy stem 170. In this manner, the user is not limited to toy 180 as provided with sexual aid 100; the user may use any toy she has in her, or her partner(s) collection(s). When a user wished to attach toy 180 to sexual aid 100, she will insert toy male attaching means 173 into the base of toy 180. The user will then insert base male attaching means 172 into bar aperture 113 and secure toy stem via toy stem securing means 171.

As shown in FIG. 4, base aperture 113 is shown in the center of bar 110 and may be threaded to accommodate toy stem 170. In this embodiment, toy stem 170 is inserted into toy stem aperture 130 and secured with toy stem securing means 171. As shown in FIG. 4, base male attaching means 173 and toy male attaching means 172, and toy stem securing means 171 are shown in a substantially threaded configuration, however, it should be understood that any coupling relationship sufficient to attach toy 180 to base 110 may be used, including but not limited to, adhesives, friction fit, detent and catch, or other suitable affixing means. Further, FIG. 4 depicts toy stem 170 and toy stem securing means 171 in a substantially nut and bolt configuration secured by a threaded relationship, however, it should be understood that other configurations and securing means are contemplated within the present invention.

Referring now to FIGS. 5 and 6, an alternative embodiment of left handle 150 and right handle 130 is shown. In this embodiment, left handle 150 comprises extended left handle coupling means 190 and right handle 130 comprises extended right handle coupling means 200. In this manner, a user may adjust the length of left handle 150 and right handle 150 to accommodate multiple users and different body types.

In this embodiment, extended left handle coupling means 190 comprises an extended left grip connector 191 having an extended left grip connector tab 192 and a plurality of extended left grip connector apertures 193. Extended left handle coupling means 190 further comprises extended left clevis connector 194 having a plurality of extended left handle connector tabs 195 and a pair of left extended delis connector tabs 196. By way of example, extended left clevis connector 194 comprises two left extended clevis connector tabs 196, however is should be understood that it is an object of the present invention to accommodate any number of extended left clevis tabs 196 that may extend the length of left clevis connector 194. Similarly, the present figure shows the number of left grip connector apertures 193 to be five, however, it is an object of the present invention to accommodate any number of extended left grip connector apertures 193 that may extend the length of left clevis connector 191.

Similarly, extended right handle coupling means 200 (shown in FIG. 6) comprises an extended right grip connector 201 having an extended right grip connector tab 202 and a plurality of extended right grip connector apertures 203. Extended right handle coupling means 200 further comprises extended right clevis connector 204 having a plurality of extended right handle connector tabs 205 and a pair of right extended clevis connector tabs 206. By way of example, extended right clevis connector 204 comprises two extended right clevis connector tabs 206 however is should be understood that it is an object of the present invention to accommodate an any number of right clevis connector tabs 206 that may extend the length of extended right clevis connector 204. Similarly, the present figure shows the number of extended right grip connector apertures 203 to be five, however, it is an object of the present invention to accommodate any number of extended right grip connector apertures 203 that may extend the length of extended right grip connector 201.

It should be understood that the tabs and apertures of extended left handle coupling means 190 and extended right handle coupling means 200 are configured to have the same measurements and dimensions as left handle 150 and right handle 130. Thus, as can be seen in FIGS. 5 and 6, left grip 152, left grip receptacle 153, and left grip receptacle aperture 154 are configured to removably receive extended left handle coupling means 190 as shown. Similarly, right grip 132, right grip receptacle 133, and right grip receptacle aperture 134 are configured to removably receive extended right handle coupling means 200 as shown. It should further be understood that extended left handle coupling means 190 and extended right handle coupling means 200 are interchangeable. For the sake of simplicity, the extended handles 190/200 are defined in terms of “left” and “right”, however, it is an object of the present invention that the user may use either handle on either side of base 110 and with either receptacle 114/116.

When the user wishes to increase the length of the handles of sexual aid 100, he or she may begin by attaching the extended handles 190/200 to base 110 or a receptacle 114/116. It should be understood that the order in which the user assembles the handles 190/200 is not important and when attaching extended handles 190/200, the steps are similar to those discussed above. By way of example, the steps of assembly are discussed below, however it is an object of the present invention that the user may assemble the pieces in any manner he or she chooses.

By way of example, then, to assemble extended left handle coupling means 190, the user will then attach extended left handle coupling means 194 to clevis 160 via left clevis connector tab 159. Left clevis connector tab 159 is depressible and comprises a diameter that is less than the diameter of extended left clevis connecter tab aperture 196. The user will depress left clevis connector tab 159 and insert extended left clevis connector 194 into left clevis receptacle 162. Thus, when left clevis connector tab 159 comes into contact with extended left clevis connector 194, extended left clevis connector tab 196 remains depressed until it comes into contact with left clevis tab receptacle 162, at which point left clevis connector tab 159 springs out and through left clevis connector tab receptacle 162 and secures extended left clevis connector 194 to left clevis 160.

In order to attach left grip 152 to extended left handle coupling means 190, the user will place left grip receptacle 153 over extended left grip connector 191. Extended left grip connector tab 192 is depressible and comprises a diameter that is less than the diameter of grip receptacle aperture 154. Thus, when extended left grip connector tab 192 comes into contact with left grip receptacle 153, when extended left grip connector tab 192 remains depressed until it comes in contact with left grip receptacle aperture 154, at which point when extended left grip connector tab 192 springs out and through left grip receptacle aperture 154 and secures left grip 153 to left handle coupling means 155. FIG. 6 depicts a completely assembled extended left handle 150 in the manner described above.

Similarly, when the user wishes to attach extended right handle 130, she will repeat the same steps. By way of example, then, the user will then attach extended right handle coupling means to right grip 132 to extended right handle coupling means 200, the user will place right grip receptacle 133 over extended right grip connector 201. Extended right grip connector tab 202 is depressible and comprises a diameter that is less than the diameter of right grip receptacle aperture 134. Thus, when extended right grip connector tab 202 comes into contact with right grip receptacle 133, when extended right grip connector tab 202 remains depressed until it comes in contact with right grip receptacle aperture 134, at which point when extended right grip connector tab 202 springs out and through right grip receptacle aperture 134 and secures right grip 133 to right handle coupling means 135. FIG. 6 depicts a completely assembled extended right handle coupling means 200 in the manner described above.

Thus, in order to assemble this embodiment of sexual aid 100 for use, the user will attach extended left handle coupling means 190 and extended right handle coupling means 200 to base 110. As shown in FIG. 6, left handle 190 and extended right handle coupling means 200 are attached to bar 111, however it should be understood that extended left handle coupling means 190 and extended right handle coupling means 200 may be attached to left receptacle 114 and right receptacle 116 in the manner as shown and described in FIG. 2. It should further be understood that, in alternative embodiments (not shown), extended left handle coupling means 190 may be attached to bar 111 while extended right handle coupling means 200 may be attached to right receptacle 116 or right handle 130 may be attached to bar 111 and left handle 150 may be attached to left receptacle 114. In this manner, and in this particular embodiment, base 110 and either or both handles 150/190/130/200 are individually, and as a group, customizable to the user's preference, number of partners, and body type.

Optionally, in this embodiment, the user may also choose to extend the length of the base in the manner as described above. For example, after or before attaching extended left handle coupling means 190 and/or extended right handle coupling means 200, the user will position left clevis 160 over bar 111 such that left clevis apertures 163 are positioned over the corresponding base aperture. The user will then secure left clevis 160 to base 110 by inserting left bar peg 118 through left bar peg aperture 112 and left clevis apertures 163. In alternative embodiments (shown in FIG. 2), left clevis 160 is positioned over left receptacle 115 such that left clevis apertures 163 are positioned over the preferred left receptacle aperture 115 and secured with left receptacle peg 151. In this manner, the user may determine the preferred width of base 110. It should be understood that it is an object of the present invention that left clevis 160 and right clevis 140 may also attach to left receptacle 114 and right receptacle 116 via the left receptacle apertures 115 and the right receptacle apertures 117 in the same manner as described above.

Finally, as the foregoing discussion makes clear, when in use in either embodiment, sexual aid 100 is positioned such that a user's preferred orifice is positioned substantially over toy 180. In this manner, sexual aid 100 is configured for giving and receiving pleasure to one or more users that have differing body types, abilities, preferences, or needs.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A device for giving and receiving sexual pleasure comprising:
a first handle assembly;
a second handle assembly; and
an adjustable bar having a first aperture on a first side, a second aperture on a second side, and a stem and whereby the adjustable bar is positioned substantially between the first handle assembly and the second handle assembly.

2. The device of claim 1 wherein the first handle assembly further comprises a first clevis, a first shaft, and a first gripping means.

3. The device of claim 1 wherein the second handle assembly further comprises a second clevis, a second shaft, and a second gripping means.

4. The device of claim 1 wherein the first gripping means comprises a handle that is substantially semicircular.

5. The device of claim 1 wherein the second gripping means comprises a handle that is substantially semicircular

6. The device of claim 1 wherein the adjustable bar further comprises a first end and a second end and wherein the first end is substantially hollow and whereby the second end is slidably inserted or removed from first end to extend the length of the adjustable bar.

7. The device of claim 2 wherein the first clevis further comprises a first pin that is inserted into first aperture and through the forked ends of the first clevis to connect the first handle assembly to the first end of the adjustable bar.

8. The device of claim 2 wherein the bottom of the first shaft is removably attached to the top of the first clevis and the top of the first shaft is removably attached to the first gripping means.

9. The device of claim 3 wherein the second clevis further comprises a second pin that is inserted into second aperture and through the forked ends of the second clevis to connect the second handle assembly to the second end of adjustable bar and opposite the first handle assembly on one end of the adjustable bar.

10. The device of claim 3 wherein the bottom of the second shaft is removably attached to the top of the second clevis and the top of the second shaft is removably attached to the first gripping means.

11. The device of claim 2 wherein the first shaft is adjustable and further comprises a first shaft adjustment position, a first shaft locking position, a first pair of cylinders, the first cylinder of said first pair of cylinders being substantially hollow and comprising a first plurality of apertures, the second cylinder of said first pair of cylinders having a first plurality of depressible pegs and wherein
the first plurality of apertures disposed partially along the length of said first cylinder and at least one aperture of said first plurality of apertures has a circumference that is greater than the circumference at least one depressible peg of said at least one of said first plurality of depressible pegs;
at least one depressible peg of said first plurality of depressible pegs is disposed partially along the length of said second cylinder and at least one depressible peg of said first plurality of depressible pegs has a circumference that is less than the circumference of at least one aperture of said plurality of apertures; and
wherein the second cylinder is slidably received in first cylinder and wherein said at least one depressible peg of said first plurality of depressible pegs is depressed inwardly when said second cylinder is in the first shaft adjustment position and wherein the said at least one depressible peg moves outwardly and through the said at least one aperture of the said first plurality of apertures in the first shaft locking position.

12. The device of claim 3 wherein the second shaft is adjustable and further comprises a second shaft adjustment position, a second shaft locking position, a second pair of cylinders, the first cylinder of said second pair of cylinders being substantially hollow and comprising a first plurality of apertures, the second cylinder of said second pair of cylinders having a first plurality of depressible pegs and wherein
the first plurality of apertures is disposed partially along the length of said second cylinder and at least one aperture of said first plurality of apertures has a circumference that is greater than the circumference at least one depressible peg of said at least one of said first plurality of depressible pegs;
at least one depressible peg of said first plurality of depressible pegs is disposed partially along the length of said second cylinder and at least one depressible peg of said first plurality of depressible pegs has a circumference that is less than the circumference of at least one aperture of said plurality of apertures; and
wherein the second cylinder is slidably received in first cylinder and wherein said at least one depressible peg or said first plurality of depressible pegs is depressed inwardly when said second cylinder is in the second shaft adjustment position and wherein the said at least one depressible peg moves outwardly and through the said at least one aperture of the said first plurality of apertures in the second shaft locking position.

13. The device of claim 1 further comprising an adult toy.

14. The device of claim 12 wherein the adjustable bar forms a stationary base for the adult toy.

15. The device of claim 1 wherein the stem is disposed in the planar center of, and perpendicular to, the adjustable bar such that it is equidistant from, and substantially between, the first handle assembly and the second handle assembly.
